(19) United States
(12) Patent Application Publication
(10) Pub. No.: US 2009/0283538 A1
(43) Pub. Date: Nov. 19, 2009

(54) COUNTER AND A RECORDER FOR A PILL DISPENSER

(76) Inventors: James Terence Collins, Cambridgeshire (GB); Allen John Pearson, Cambridgeshire (GB); Gregor John McLennan Anderson, Hertfordshire (GB)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(21) Appl. No.: 12/306,015

(22) PCT Filed: Jul. 5, 2007
(86) PCT No.: PCT/EP2007/056841

§ 371 Date: Dec. 22, 2008

(30) Foreign Application Priority Data
Jul. 6, 2006 (GB) 0613472.0

(51) Int. Cl. B65D 83/04; A61J 7/02

(52) U.S. Cl. 221/1; 221/2; 221/8

(57) ABSTRACT

A counter (or recorder) for a pill dispenser comprising two relatively moveable chassis components forming part of a pill dispensement mechanism, a pill delivery or dispensement channel and a counting (or recording) mechanism. The counting (or recording) mechanism comprises one or more actuation indicators, a ratchet pawl for incrementally advancing a first of the one or more actuation indicators and a drive mechanism for activating the ratchet pawl. The ratchet pawl is mounted to a first of the two chassis components. The drive mechanism is mounted to the second of the two chassis components.

The drive mechanism is connected to a pill detect feature that can move between a positive dispensement position and a negative dispensement position if the channel is clear, the negative dispensement position being such that at least a part of the pill detect feature is positioned within or blocking the pill delivery or dispensement channel.

### FIELD OF THE INVENTION

The present invention relates to a counter and a recorder for counting/recording tablets or pills as they are dispensed from a container. The counter/recorder will usually be screwed onto the neck of the container. Tablets or pills contained in the container can then be dispensed directly from the container through the counter/recorder.

### BACKGROUND OF THE INVENTION

Tablet or pill dispensers (“pill dispensers”) having counters are known in the art and are disclosed, for example, in WO2005/005280, WO2005/004786 and WO2005/004787, the disclosures of which are incorporated herein by way of reference. Those pill dispensers each screw onto the neck of a container, and the cap of the container then is used to cap the dispenser by screwing it onto a neck of the pill dispenser. The dispenser therefore fits between the cap and the container.

The above pill dispensers all have a lower casing and an upper casing, which together encase a pill dispensing mechanism that comprises a first chassis component and a second chassis component. The cap screws onto the second chassis component and the lower casing screws onto the container.

The pill dispensing mechanism allows a pill to be dispensed from an inverted container—by being inverted, gravity feeds pills from within the container into the pill dispensing mechanism. The mechanism operates upon depressing the second chassis component relative to the first chassis component (i.e. towards the container)—a single actuation. Upon that actuation, the pill dispensing mechanism will dispense a single pill from the container.

The above pill dispensers each also have an electromechanical counting mechanism. The counting mechanism counts only when a pill is dispensed. A pill will not be dispensed, for example, if the container is upright, whereby gravity would keep the pills in the bottom of the container. The count is displayed on a liquid crystal display or screen. A battery is therefore required to operate the counting mechanisms of these dispensers. The battery adds cost. Further, false readings can be displayed on the screen in the event of either an electronic malfunction or if the battery power gets too low. The present invention therefore seeks to provide a counter that does not rely upon electronics or batteries or other power sources.

Mechanical (or non-electronic) counters, i.e. counters that do not require a power source, have been developed for aerosol dispensers. One such device is disclosed in WO2004/001664, the disclosure of which is also incorporated herein by way of reference. The device in WO2004/001664 is an actuation counter; the number of actuations of the aerosol are counted and displayed on rotatable indicator wheels. The indicator wheels comprise three axially arranged, rotatable, actuation indicator wheels. One of these is a “units” wheel that is incrementally rotated (or driven) stepwise about its axis by a ratchet pawl upon each actuation of the dispenser. The next one is a “tens” wheel, which is incrementally rotated (or driven) stepwise by a knock gear upon each full rotation of the “units” wheel (this occurs after ten incremental rotations of the “units” wheel). The third wheel is the “hundreds” wheel. It is incrementally rotated (or driven) stepwise upon each tenth incremental rotation of the “tens” wheel by another knock gear.

Depending upon how the numbers are printed onto the wheels, the rotatable indicator wheels of WO2004/001664 can either count up or count down the number of actuations of the dispenser.

The mechanical counting mechanism just counts the actuations. This is useful for aerosol delivery devices because there is a dispensement upon each actuation of the dispenser. However, where an actuation does not necessarily result in a dispensement, such as with pill delivery systems, such mechanical counting mechanisms would not necessarily give an accurate dispensement count. It would therefore be desirable to provide a counter for a pill dispenser that will correctly count the number of pills being dispensed, but without requiring a battery or external power source.

Mechanical counters can also suffer from the following problems: if the counter has counted down to 000, or has counted up to 999 (assuming the hundreds wheel is numbered all the way to 9), then if the aerosol dispenser is continued to be used, the rotatable indicator wheels is likely to continue to rotate, thereby displaying an incorrect count upon that next actuation. For example, if the counter is counting down, after 000, 999 would be displayed. Alternatively, if it is counting up, after 999, 000 would be displayed. To avoid this problem, however, WO2004/001664 provides a counter lock-out.

It would nevertheless also be desirable to provide an alternative counting mechanism that will not provide false count information upon reaching either a count of zero or a preferred maximum (or minimum) count. It would also be desirable to provide an alternative recording mechanism.

### SUMMARY OF THE INVENTION

The present invention provides a counter (or a dose counter or a recorder) for a pill dispenser, the counter comprising:
two relatively moveable chassis components forming part of a pill dispensement mechanism;
a pill delivery or dispensement channel for a pill or tablet to pass through for dispensement; and
a counting mechanism comprising:
   one or more actuation indicators;
   a ratchet pawl for incrementally advancing a first of the one or more actuation indicators; and
   a drive mechanism for activating the ratchet pawl; the ratchet pawl being mounted to a first of the two chassis components;
the drive mechanism being mounted to the second of the two chassis components such that, by moving the two chassis components relative to each other, the drive mechanism is moved relative to the ratchet pawl and the pill dispensement mechanism is actuated;
wherein:
the drive mechanism is connected to a pill detect feature that can move between a positive dispensement position and a negative dispensement position if the channel is clear, the negative dispensement position being such that at least a part of the pill detect feature is positioned within or blocking the pill delivery or dispensement channel, whereby the non-presence of a pill within the channel for dispensement, and therefore a failed dispensement, is confirmed, the movement from that positive dispensement position to the negative dispensement position preventing the drive mechanism from activating the ratchet pawl as the drive mechanism moves relative to the ratchet pawl.

As a result of the drive mechanism not activating the ratchet pawl during a failed dispensement, the ratchet pawl will not advance the first actuation indicator upon moving the chassis components relative to each other. This means that the counter(or dose counter or recorder) will not count actuations that do not cause the dispensement of a pill.

Preferably the positive dispensement position of the pill detect feature is such that no part of the pill detect feature is positioned within the pill delivery or dispensement channel. Instead the channel is clear so that a pill, or a line of pills, can be located in the channel.

Preferably the pill detect feature forms part of the channel, and most preferably it forms a wall (or part of a wall) of the channel.

Preferably, during a successful pill dispensement, the dispensed pill is bearing against the pill detect feature as the pill passes through the channel, whereby the pill detect feature cannot move into its negative dispensement position.

Preferably the drive mechanism and the pill detect feature are integrally formed as a single component of the counting mechanism.

Preferably the drive mechanism is a rotatable drive gear.

Preferably the pill detect feature is a pill detect arm. Preferably it extends perpendicular to the axis of rotation of the drive gear. Preferably a pill engaging surface of the pill detect arm extends parallel to the direction of travel of a pill through the pill dispensement channel during dispensement of that pill through the pill dispensement channel.

Preferably the movement of the pill detect feature is a pivoting or rotational motion of it.

Preferably the counting mechanism is a purely mechanical counter, i.e. no electronics.

Preferably the or each actuation indicator is an indicator wheel, more preferably a counter wheel.

Preferably the or each actuation indicator rotates about its central axis, e.g. so as to alter its indicia or count.

Preferably the actuation indicator has a plurality of indicia thereon that will come into registration with a window of the counter, one indicia at a time, as the indicator advances or rotates, so as to display its count, through the window, by means of that registered indicia. The window preferably is large enough to allow an indicia of two or more actuation indicators to come into registration, or be in registration, at the same time.

The present invention also provides a recorder for a pill dispenser to record dispensing of pills by the pill dispenser on actuation thereof, the recorder having a mechanical recording mechanism which includes a driver for driving the recording mechanism in response to dispensing of a pill by the pill dispenser on actuation thereof, wherein the driver has a driving mode, in which it drives the recording mechanism, and a non-driving mode, in which it does not drive the recording mechanism, and wherein the driver is configured and arranged so as to adopt the non-driving mode when no pill is dispensed on actuation of the pill dispenser and to adopt the driving mode when such actuation results in dispensing of a pill.

Preferably the driver is configured and arranged to be placed in the driving mode by a pill being dispensed on actuation of the pill dispenser.

Preferably the driver's driving and non-driving modes correspond to different positions of the driver in the recorder.

Preferably the driver has a drive surface for engaging a driven surface of the recording mechanism to drive the recording mechanism and wherein the drive surface is only in driving engagement with the driven surface in the driving mode of the driver.

Preferably the drive and driven surfaces are gear forms.

The counter, the dose counter or the recorder may be incorporated into a pill dispenser, e.g. fitted substantially within the casing of a pill dispenser.

Preferably the dispenser has a pill dispensing path which a pill traverses when dispensed on actuation of the dispenser, wherein the driver is configured and arranged to be maintained in its driving mode by a pill traversing the pill dispensing path on actuation of the dispenser (a “dispensing actuation event”) and to adopt the non-driving mode if no pill traverses the path on actuation of the dispenser (a “non-dispensing actuation event”).

Preferably the driver has a control surface configured and arranged for a pill to bear against during a dispensing actuation event to maintain the driver in the driving mode.

Preferably the pill dispenser is attached to a container containing a plurality of pills or tablets. Preferably the pill dispenser is screwed onto an open neck of the container. Preferably the cap of the container is attached onto a neck of the pill dispenser. The neck of the pill dispenser, therefore, should have a corresponding shape to the neck of the container.

Preferably the pill detect feature comprises a pill engaging surface. Preferably that pill engaging surface defines at least a part of a first wall of the pill dispensement channel of the pill dispenser. Preferably a flange extends from a surface of the first of the two chassis components to define a wall of the pill dispensement channel. That wall opposes the pill engaging surface. Preferably third and fourth walls of the channel are provided by two further flat surfaces or flanges provided on (or for) the two chassis components, one of which is preferably the surface from which the first-mentioned flange extends.

The four walls defining the channel preferably define a substantially square or rectangular channel, suitable for passing a disk shaped tablet or pill therethrough, since shaped tablets or pill have a generally rectangular profile in elevation. However, other shapes for the channel may be provided for non-disk shaped tablets or pills. In essence, however, the channel's section is preferably designed to allow uninhibited passage therethrough of a tablet or pill of a predetermined size and shape, but with the tablet or pill being in a controlled orientation.

Preferably two or more actuation indicators are provided, both in the form of rotatable actuation indicator wheels. Preferably they are interlinked by one or more knock gears. The knock gears allow an adjacent wheel to be incrementally advanced upon an appropriate degree of rotation of the preceding rotatable actuation indicator wheel. The appropriate degree of rotation will usually be approximately 360°. In preferred arrangements of this type, if there are N wheels, there will be N−1 knock gears.

Preferably the rotatable actuation indicator wheels comprise a first wheel—the units wheel, and a second wheel—the tens wheel. A hundreds wheel might also be provided. A fourth wheel, if provided, would be a thousands wheel.

A further incremental wheel might be positioned in front of the units wheel, e.g. a “part day” or an “hours” wheel if the units wheel signifies the number of days. That additional wheel might then indicate time intervals or periods within each day. For example, the additional wheel might be a half day indicator wheel having AM and PM indicators repeating around the wheel (or equivalent indicators for a chosen local language). A knock gear could then be provided to knock on the units wheel every two knocks of the half day indicator wheel. This would be useful where a pill needs to be taken twice a day—a glance at the count would advise when the next pill should be taken—AM or PM, and the units wheel would also give the date on which the pill should be taken, e.g. 2^{nd} or 3^{rd}, etc. The counting mechanism, therefore acts as an aide memoire for the user.

In an alternative, but preferred counting mechanism, in accordance with a second aspect of the present invention, there is provided an arrangement for the actuation indicators of the counter in which the units indicator provides both a count, by including units indicia, and medication interval indicia, e.g. alternating AM and PM indicia. In a preferred embodiment the combined indicia read: 1 PM, 2 AM, 3 PM . . . etc., (or equivalent indicators for a chosen local language) for pills being taken twice a day.

With this preferred and advantageous arrangement, the counting mechanism can both count the usage of the pills (or if counting down, count the number of pills left in the container), and also provide an aide memoire as to when the next pill should be taken by way of the medication interval indicia.

For different dose intervals, different medication interval indicia would be provided, e.g. times or even a second set of numbers. The combined indicia might then read, for example: 1/9 am, 2/11 am, 3/1 pm, 4/3 pm . . . for pills that need to be taken every two hours, the first numbers providing the count and the second half of each indicia providing the time at which the dose should be taken.

Again, instead of counting up the, counting mechanism might more usefully count down: 4/9 am, 3/11 am, 2/1 pm, 1/3 pm.

When the numbers count down, the counting mechanism will usually be initially set to a number (a predetermined starting number) reflecting the number of pills expected to be in the container (or more usually that expected number, but less a few to allow for a few reserve pill in case of a late collection of a new supply of pills). The indicia, as they count down, would then tell the user how many pills are remaining (excluding any “additional” pills), and therefore will give an indication of how much longer their supply of pills will last.

Preferably the count is indicated by the indicia through a window, which is preferably fitted with a transparent plastics or glass windowpane. The window is preferably formed in part of an outer casing of the pill dispenser.

Preferably a shutter device is also provided. The shutter device is preferably provided as a separate but final wheel—e.g. the third wheel if just a “units” wheel and a “tens” wheel are provided. The shutter wheel is provided with a shutter that will draw over the indicated count upon the final desired count being reached and preferably also a hub by means of which the device is mounted onto the same axle as the actuation indicators.

The shutter device might also be actuated by a knock gear. However, it is more preferably actuated by a drive pin that extends from a side of the preceding actuation indicator(e.g. an actuation wheel, such as a “tens” wheel). This is because the drive pin is preferably provided for advancing the shutter just once, and this arrangement reduces the number of components for the counter.

A shutter might alternatively be provided as a part of one of the actuation indicators, e.g. where the indicators are wheel. Conveniently, the shutter may be provided as part of a “tens” wheel (or, if used, a “hundreds” wheel); in other words, as part of the outermost (highest number denoting) actuation indicator wheel.

The shutter is preferably provided with no indicia, although “empty” or such like might be usefully inscribed onto it for displaying through the window—the shutter draws over the actuation indicator(s), between the indicator(s) and the window, upon it being advanced by the winding on of the counter beyond its preferred final count.

Preferably the outer casing comprises an upper casing and a lower casing. Preferably the window is provided in the upper casing.

Preferably the casing components are separable to allow servicing of the counting mechanism contained within the casing, or for simplified assembly/disassembly of the pill dispenser (e.g. for recycling). Preferably the upper casing and the lower casing are provided with snap fit connectors for allowing them to be snap fitted together and to allow them to be readily separated again.

Preferably the casing encloses the actuation indicators of the counter.

Preferably a dispensement nozzle extends out of the casing. Preferably the nozzle is integral to the second chassis component. It is in communication with the channel of the pill dispensement mechanism to allow a dispensed pill or tablet to be dispensed thereat for retrieval by the user for administration.

The nozzle may have a screwthread thereon. Preferably the screwthread allows a cap of a container, onto which container the pill dispenser is adapted to be fitted, to be screwed onto the pill dispenser. Then, both the container and the pill dispenser can be closed by the same cap.

Preferably the pill dispenser comprises an internal screwthread to allow the pill dispenser to be screwed onto a threaded neck of the container. Preferably the internal screwthread is provided on the inside of the outer casing.

Preferably an extension piece defining an opposing wall is provided on the first chassis component that opposes the outer casing. Preferably, it is generally tubular and preferably it opposes the internal screw thread. Most preferably it is adapted to fit within the neck of the container to allow a more secure attachment of the pill dispenser onto the container. Most preferably the opposing wall fits within the neck of the container to form a pill seal so as to guide pills from the container into the pill dispenser when the container, and the pill dispenser fitted thereto, are inverted ready for pill dispensement. The pill seal is preferably airtight, although the screwthread, or a separate seal, as is conventional with screwtop caps, may instead provide an airtight seal, as is conventional with screwtop caps for medicine containers.

Preferably the extension piece having the opposing wall also comprises a generally axially arranged lumen that is in communication with the channel. The lumen is open towards the inside of the container. Pills from the container can then directly enter the pill dispenser through the lumen when the pill dispenser and container arrangement is inverted.

Preferably the lumen has a substantially tapered or conical shape, so as to narrow towards the channel. This will help to cause pills or tablets from the container to align themselves as they approach the channel so that they are correctly oriented for passing through the channel. The taper or cone shape is preferably generally rectangular in section (e.g. a tapered slot) for assisting in this pre-orientation of the pills.

Preferably the first chassis component and the second chassis component are biased apart so that the pill dispensement mechanism resets after each actuation. The bias is preferably provided by a biasing element, typically a spring, an example being a compressed coil spring.

Preferably the drive gear is mounted for rotation about a fixed axis relative to the second chassis component, with the ratchet pawl and actuation indicators being mounted for rotation about one or more fixed axes relative to the first chassis component. Preferably the axis of the ratchet pawl is parallel to the axis of the drive gear, and remains so during the relative motion of the axes as the two chassis components move relative to each other during an actuation of the pill dispenser.

Preferably the axis of rotation of the ratchet pawl is coaxial with the axis of rotation of an or each rotatable actuation indicator.

Preferably the ratchet pawl and each rotatable actuation indicator are all fitted on a single axle for rotation thereabout.

Preferably the axis of rotation of the or each knock gear is fixed relative to the axis of rotation of the or each rotatable actuation indicator associated therewith. Preferably that axis is parallel to but spaced from the axis of rotation of the or each rotatable actuation indicator associated therewith.

The present invention also provides a method of counting positive actuations of a pill dispenser, a positive actuation comprising a pill dispensement from the pill dispenser upon an actuation of the pill dispenser, the method comprising providing a pill dispenser having a counter, the pill dispenser having a pill dispensement mechanism, an actuation of which requiring a motion of a first chassis component relative to a second chassis component in order for a pill dispensement to occur, by which motion a pill can move along a channel of the pill dispenser, wherein upon a positive dispensement, a tablet or pill passing along the channel will engage a pill engaging surface of a pill detect feature mounted within the pill dispenser as the pill or tablet passes out of or through the channel of the pill dispenser, that engagement maintaining the pill detect feature in a first position relative to a feature of the pill dispenser, that feature being either the channel or one of the two chassis components, whereby the counter will be advanced by that relative motion of the two chassis components so as to count the actuation, and wherein, upon a negative actuation, a negative actuation comprising no pill dispensement from the pill dispenser upon an actuation of the pill dispenser since a pill for dispensement upon that actuation is not present in the channel, no pill will engage the pill engaging surface of the pill detect feature, thereby allowing the pill detect feature to move relative to that feature (either the channel or that one of the two chassis components) upon the actuation of the pill dispensement mechanism, which movement disables the counter or prevents the counter from counting that actuation.

Preferably the relative movement of the two chassis components is a linear movement.

Preferably the channel is substantially straight, having a central axis. Preferably that axis extends between the container and the nozzle, substantially along centrelines thereof.

Preferably the relative movement of the two chassis components is a linear movement that is parallel to the axis of the channel.

Preferably the movement of the pill detect feature involves a rotation of both the pill detect feature and a drive gear of the counter, the drive gear being connected to the pill detect feature.

Preferably the drive gear engages a ratchet pawl of the counter.

Preferably the relative movement of the chassis components cause a primary drive movement of the drive gear, that movement being relative to the axis of rotation of the ratchet pawl.

Preferably the movement of the chassis components is a linear movement that is perpendicular to an axis of rotation of the ratchet pawl.

The movement of the pill detect feature upon a negative dispensement preferably causes a secondary non-drive movement of the drive gear, which secondary movement is preferably a rotation. That secondary movement is to prevent the drive gear from driving the ratchet pawl during the drive gears primary movement, which primary movement preferably still occurs during the relative movement of the chassis components even during this negative dispensement.

Upon a positive dispensement, the primary movement of the drive gear is allowed to drive the ratchet pawl since a secondary movement to prevent the drive gear from driving the ratchet pawl during the drive gears primary movement does not occur.

The drive gear preferably drives the ratchet pawl due to an engagement of teeth of the drive gear with teeth of the ratchet pawl.

Preferably the counter and pill detect feature of this second aspect of the present invention form the counting mechanism of the first aspect of the present invention, and are parts of a counter (or a dose counter or a recorder) in accordance with the first aspect of the present invention.

Preferably the rotation of the pill detect feature during a negative dispensement causes the swinging of an arm of the pill detect feature through or into the pill dispensement channel, which swinging results in a rotation of the drive gear about its axis as the drive gear moves relative to the axis of the ratchet pawl, whereby the drive gear rotates around the ratchet pawl so as not to rotate the ratchet pawl about the ratchet pawl's axis as a result of the motion of the drive gear relative to the axis of the ratchet pawl. However, during a positive dispensement, no such swinging of the arm occurs, whereby the drive gear does not rotate, so that the movement of the drive gear relative to the axis of the ratchet pawl causes rotation of the ratchet pawl.

These and other features of the present invention will now be described by way of example only with reference to the accompanying drawings.

### BRIEF DESCRIPTION OF THE DRAWINGS

FIG. 1 shows a perspective view of a pill dispenser of the present invention fitted onto a container;

FIG. 2 is an exploded perspective view of the pill dispenser and its mechanical counter (or recorder);

FIGS. 3 to 12 illustrate how to dissemble and reassemble the pill dispenser and counter;

FIGS. 13 and 14 schematically illustrate the operation of the ratchet paw, the pill detect feature and the drive gear of the counter during a positive dispensement;

FIG. 15 schematically illustrates the operation of the ratchet pawl, the pill detect feature and the drive gear of the counter during a negative dispensement; and

FIGS. 16 to 23 illustrate the operation of a shutter mechanism for the counter.

### DETAILED DESCRIPTION OF THE DRAWINGS

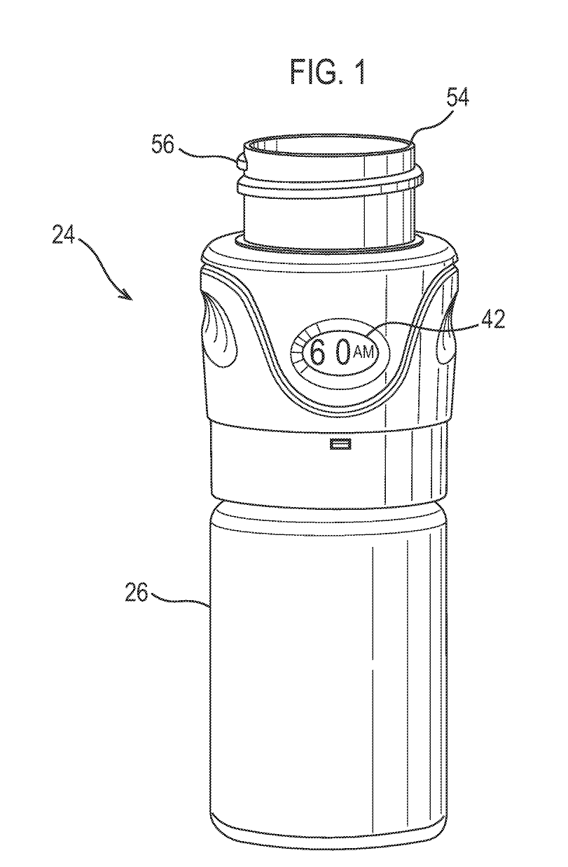

Referring first to FIG. 1 there is shown a pill dispenser 24 fitted onto a container 26. The container 26 is a typical medicament container comprising a plurality of pills or tablets 28 (one is shown in FIG. 13). The container 26 comprises a neck (not shown) onto which the pill dispenser 24 has been screwed. For this purpose, the pill dispenser has an internal screwthread 58 (see FIG. 13). Although not shown, the neck of the container 26 corresponds in shape generally with the dispensement nozzle 54 that is provided at the top of the pill dispenser 24. The dispensement nozzle 54 and neck are provided so as to have the same size (diameter) and thread (56 for the nozzle 54) so that the same cap (not shown) can be used both for closing the container 26 and for closing the pill dispenser 24.

The pill dispenser 24 has a mechanical actuation indicator counter or counting mechanism 10, which is located inside the pill dispenser 24. The count of the counting mechanism 10 is displayed through a window 42 in the side of the pill dispenser 24.

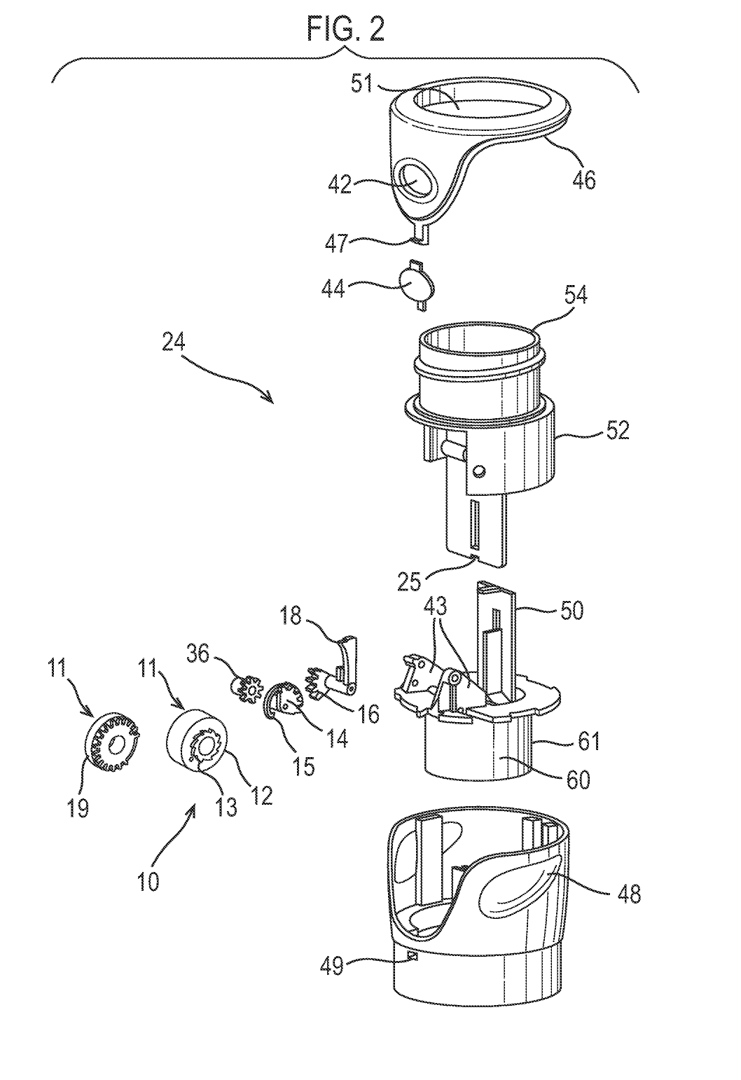

Referring now to FIG. 2, an exploded perspective view of most of the components of the pill dispenser 24 and counting mechanism 10 can be seen. The counting mechanism 10 has at least five moving parts. These moving parts include two indicator wheels 11, a knock gear 36, a ratchet pawl 14 and a pill detect feature 18 having a drive gear 16 thereon.

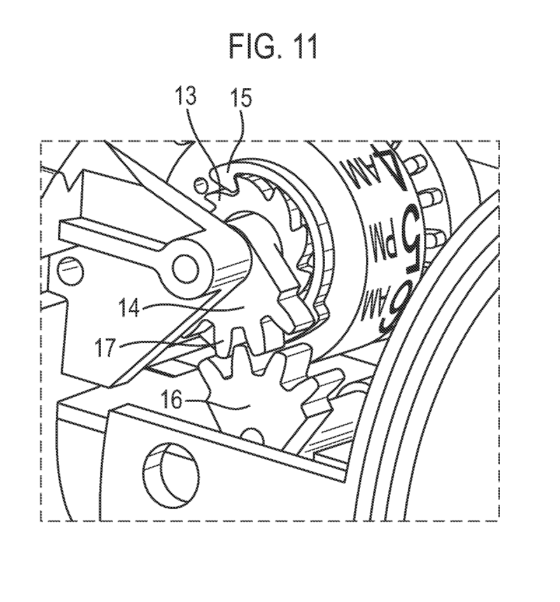

One of the indicator wheels 11 is the first rotatable actuation indicator wheel—the units wheel 12. The units wheel 12 comprises a saw-tooth surface, or ramped gear form 13 (see FIG. 11) for engagement by a sprocket of a ratchet arm 15 of the ratchet pawl 14.

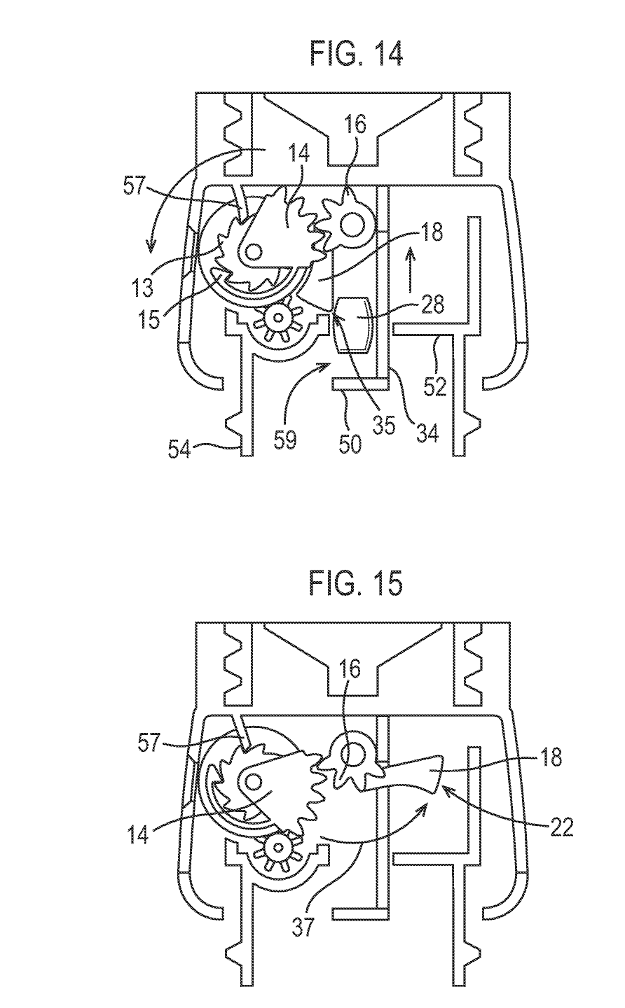

As shown in FIG. 14, the ratchet pawl 14 comprises a gear form 17 (shown clearly in FIG. 11) for engagement by the drive gear 16, which drive gear 16 has a matching gear form.

The ratchet pawl 14 and the two wheels 11 are mounted on a fixed axle 29 to two axle support legs 43 for rotation thereabout.

The drive gear 16 is connected to the pill detect feature—pill detect arm 18. They together form a unitary structure.

The knock gear 36 is provided for knocking the second rotatable actuation indicator wheel—the tens wheel 19—upon each full rotation of the units wheel 12. The knock gear 36 is a conventional gear for this type of counter (a barrel counter). Indeed, a ratchet pawl, a knock gear, a units wheel and a tens wheel, each of a similar construction and function to that shown in the attached drawings, are all disclosed in the previously mentioned prior art document, WO2004/001664. Accordingly, a full discussion of their features, and their functional interrelation, is not required here.

The various elements of the counting mechanism 10 are mounted on first and second chassis components 50, 52 of the pill dispenser 24. The first chassis component 50 slidingly engages with (and into) the second chassis component 52.

The second chassis component 52 has the dispensement nozzle 54 integrally formed at one end of it.

Relative axial sliding of the two chassis components 50, 52 allows a pill to advance through a pill dispensement channel 32 (FIG. 13) of the pill dispenser 24, whereby pills can be dispensed from the container 26, through the pill dispensement channel 32 and the dispensement nozzle 54, one at a time. This working mechanism 21 of the pill dispenser 24 will be described in further detail below, with reference to FIGS. 13, 14 and 15.

The unitary structure of the drive gear 16 and the pill detect arm 18 is rotatably mounted to the second chassis component 52 on a fixed axis. The indicator wheels 11, the knock gear 36 and the ratchet pawl 14 are all rotatably mounted to the first chassis component 50 on another fixed axis. By this arrangement, relative motion of the first and second chassis components 50, 52 will move the pill detect arm 18 and drive gear 16 relative to the indicator wheels 11 and the ratchet pawl 14. This is in addition to allowing the pill dispensement function.

Referring again to FIG. 2, an outer casing encases the counting mechanism 10 and the main bodies of the chassis components 50, 52. The outer casing is in two parts. There is a lower casing 48 that has the internal screwthread 58 for screwing onto the neck of the container 26. The lower casing 48, during the assembly of the pill dispenser, receives the first chassis component 50 therein. The second chassis component 52 then can then be stacked onto that first chassis component 50. An upper casing 46 then snap-fits over (or onto) that assembly to hold the chassis components 50, 52, and the counting mechanism 10, within the outer casing.

The upper casing 46 additionally comprises a top opening 51 or hole through which the nozzle 54 of the second chassis component 52 passes.

The upper casing 46 additionally comprises the window 42 through which the indicated count from the counting mechanism 10 can be seen once the pill dispenser 24 has been assembled. For sealing or closing the window 42, a transparent windowpane 44 is provided, which windowpane 44 will preferably be glued or snap fitted into place inside the window 42.

The first chassis component 50 additionally comprises a round extension piece 60. It depends from the bottom of the first chassis component, i.e. in the opposite direction to that which the neck 54 extends from the second chassis component 52.

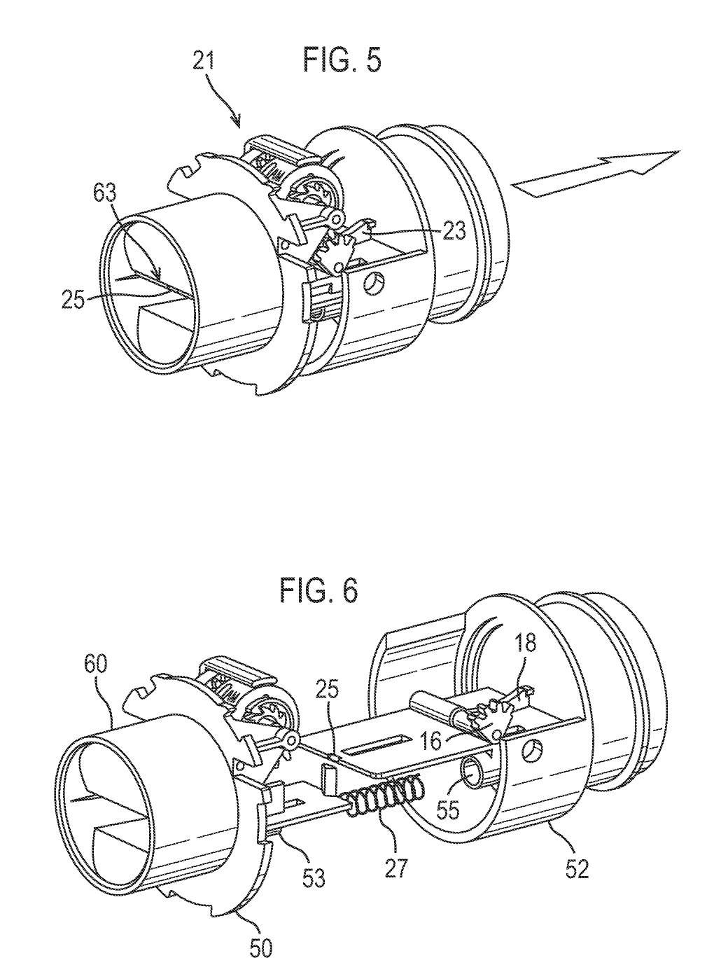

The extension piece 60 is for fitting within the neck of the container 26 and it forms an opposing wall 61 for the internal screwthread 58 of the lower casing 48. The extension piece 60 additionally has an internal formation in the form of a tapered slot 63 having a tapered wall 62 (FIGS. 5 and 13). The internal formation is for helping to align tablets or pills 28 as they pass from the container 26 into the pill dispenser 24 upon inverting the container 26 and pill dispenser 24.

The upper casing 46 is provided with three clips 47 (see FIG. 4) for snap fitting into holes 49 provided in the lower casing 48. The clips 47 and holes 49, however, may be differently arranged, or an alternative closure mechanism might be provided for the outer casing.

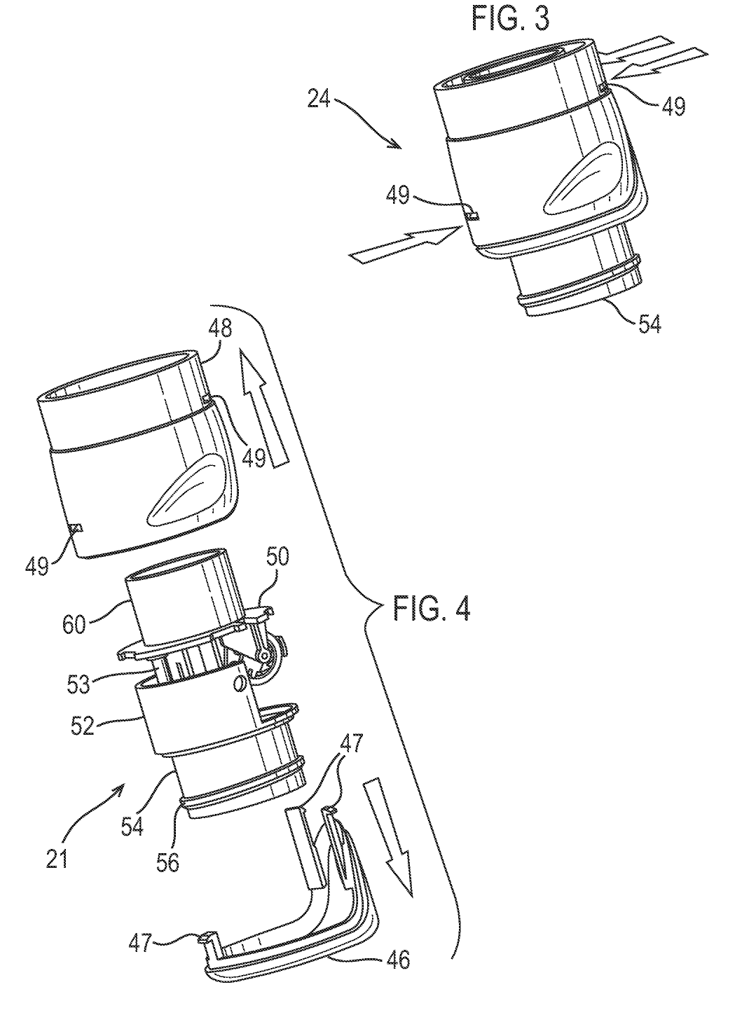

By virtue of the clips 47 in the upper casing 46 and the holes 49 for receiving the clips 47 in the lower casing 48, the dose counter 24 is simple to assemble and to take apart. A preferred method of assembly and disassembly will now be described with reference to FIGS. 3 to 11.

Referring first to FIG. 3, the assembled pill dispenser 24 is shown (upside down compared to FIG. 1). To disassemble it, the three latches or clips 47 are depressed out of the holes 49 using a pointed instrument, or perhaps a special, three-pronged tool for the purpose. The upper and lower casings 46, 48 can then be separated axially by pulling them apart. Then the working mechanism 21, which comprises the counting mechanism 10 and the pill dispensement mechanism (which includes the two chassis components 50, 52) can be accessed.

To separate the two chassis components 50, 52, first the pill detect feature should be set to a disengaged position 23, as shown in FIG. 5. In this disengaged position 23, the toothed surface 17 of the ratchet pawl 14 becomes disengaged from the teeth or gear form of the drive gear 16. Then, a clip 25, this time on the second chassis component 52 (see FIG. 5), needs to be released from the first chassis component 50. The clip 25 is found and accessed for release in or via the tapered slot 63. The clip 25 axially secures the two chassis components 50, 52. Its release then allows the two chassis components 50, 52 to be slid apart, as shown in FIG. 6.

Still referring to FIG. 6, a coil spring 27 is provided between the two chassis components 50, 52 for biasing the two chassis components 50, 52 apart. As the chassis components 50, 52 are slid apart, the spring 27 may become or fall loose. This is despite the spring 27 being fitted onto a spindle 53 that aligns with a hole 55 in the second chassis component 52 to help to prevent this. Nevertheless, if it comes loose, the spring 27 should be retained so that it can be repositioned between the two chassis components 50, 52 when the two chassis components are reassembled.

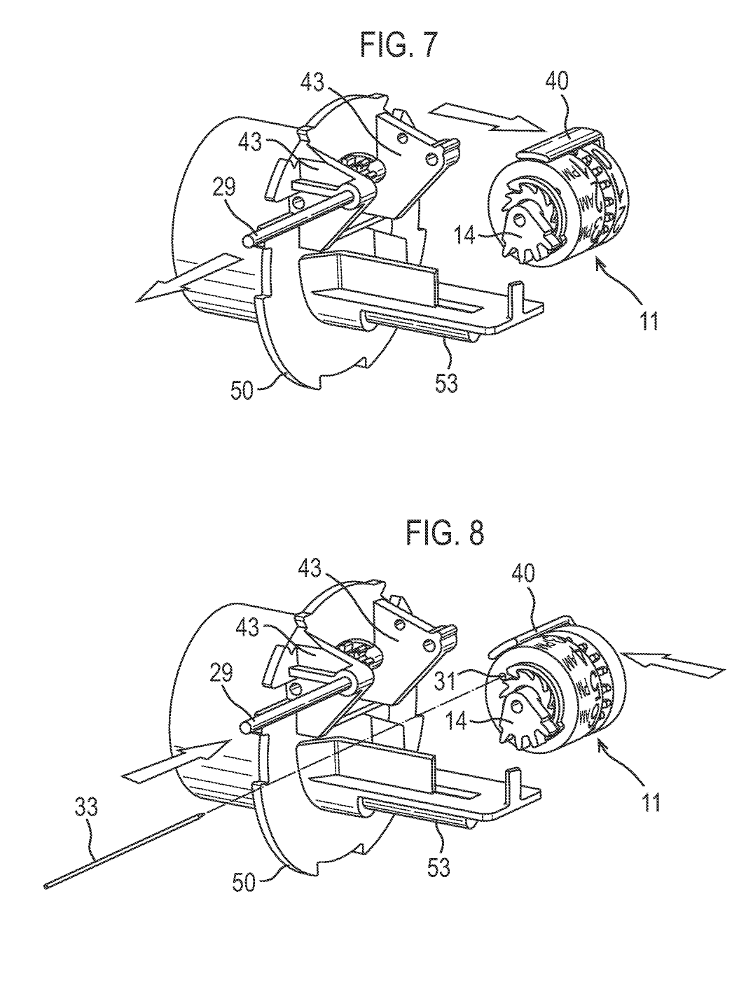

Having separated the two chassis components, the wheels 11 and ratchet pawl 14 can be disassembled from the first chassis component 50. This may be required, for example, for resetting the count on the wheels 11. To do this, the axle 29 for the wheels 11 and ratchet pawl 14 is withdrawn from the wheels 11 and ratchet pawl 14, and also from at least one of the axle support legs 43, which legs 43 are both integrally formed with the first chassis component 50 (see FIG. 7). The ratchet pawl 14 and indicator wheels 11 can then be removed from the first chassis component 50.

Once removed, the wheels 11 can then easily be reset to a preferred starting number, which number will depend upon the number of pills normally found in the particular container 26 being used. For a container comprising 70 pills, this number might be, for example, 63. This allows seven pills to remain in the container 26 after the count reaches zero, so that the user has those seven spare pills to last him until he gets a new supply of pills.

After resetting the wheels 11, the wheels 11 and the ratchet pawl 14 can be refitted to its axle 29. However, because these pieces of the counter are small, this can be fiddly. Accordingly, the wheels 11 are provided with wheel alignment holes 31, as shown in FIG. 8. The wheel alignment holes 31 allow a wheel alignment pin 33 to be fitted through the wheels 11 so as to hold the wheels 11 at their preferred starting orientation. A hole 31 is provided for each wheel 11 in such a position for allowing an alignment to be maintained at that preferred starting orientation. More than one hole 31, however, might be provided in each wheel 11 to accommodate a variety of different preferred starting orientations.

In this preferred embodiment, the alignment pin 33 is a 1 mm diameter pin.

A shutter 40 is also provided in this embodiment. It may also be reset at this time, and if it is provided with another wheel alignment hole 31, the pin 33 could extend through that hole 31 as well.

The wheels 11 and ratchet pawl 14 (the drum or barrel assembly) can then be refitted onto the first chassis component 50 by threading the axle 29 back through the centre of the wheels 11 and the ratchet pawl 14 to extend between the two axle support legs 43. Then the alignment pin 33 can be removed.

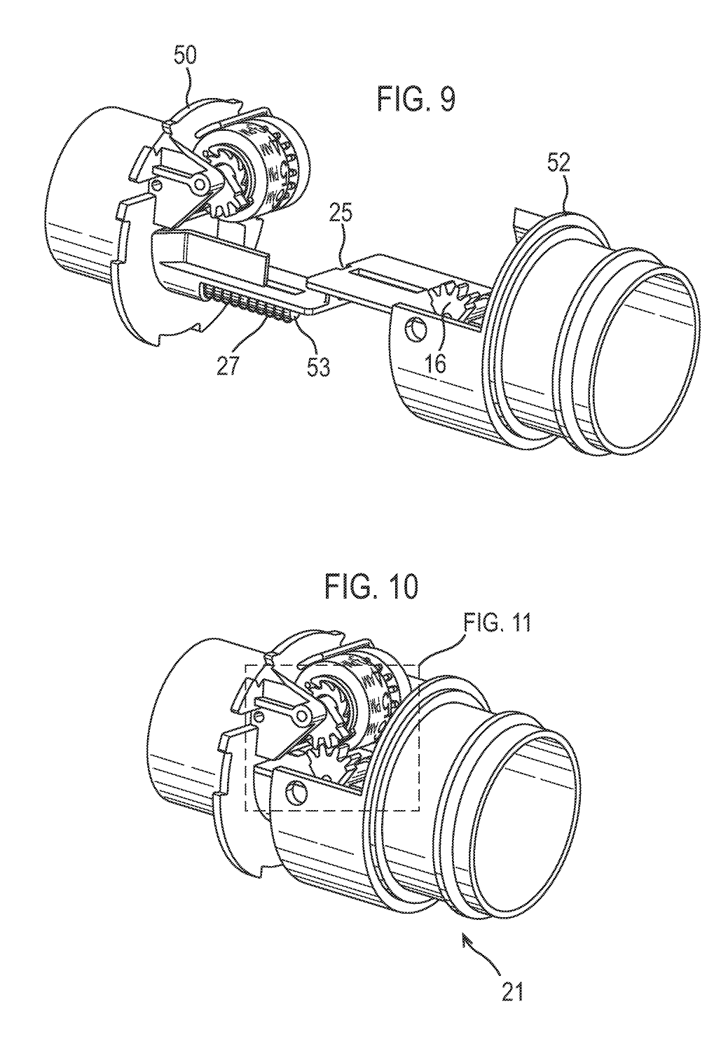

Next, as shown in FIG. 9, the spring 27 can be refitted onto its spring receiving spindle 53 (on the first chassis component 50) before reassembling the two chassis components 50, 52 by slotting them together axially. The chassis components 50, 52 will click together by virtue of the resilience of the clip 25. As they are clipped together, however, care should be taken to ensure that the drive gear 16 and the ratchet pawl 14 engage together properly, i.e. in the manner shown in FIG. 11. This will ensure that a correct operation of the ratchet system for the indicator wheels 11 will occur during each actuation of the pill dispenser 24.

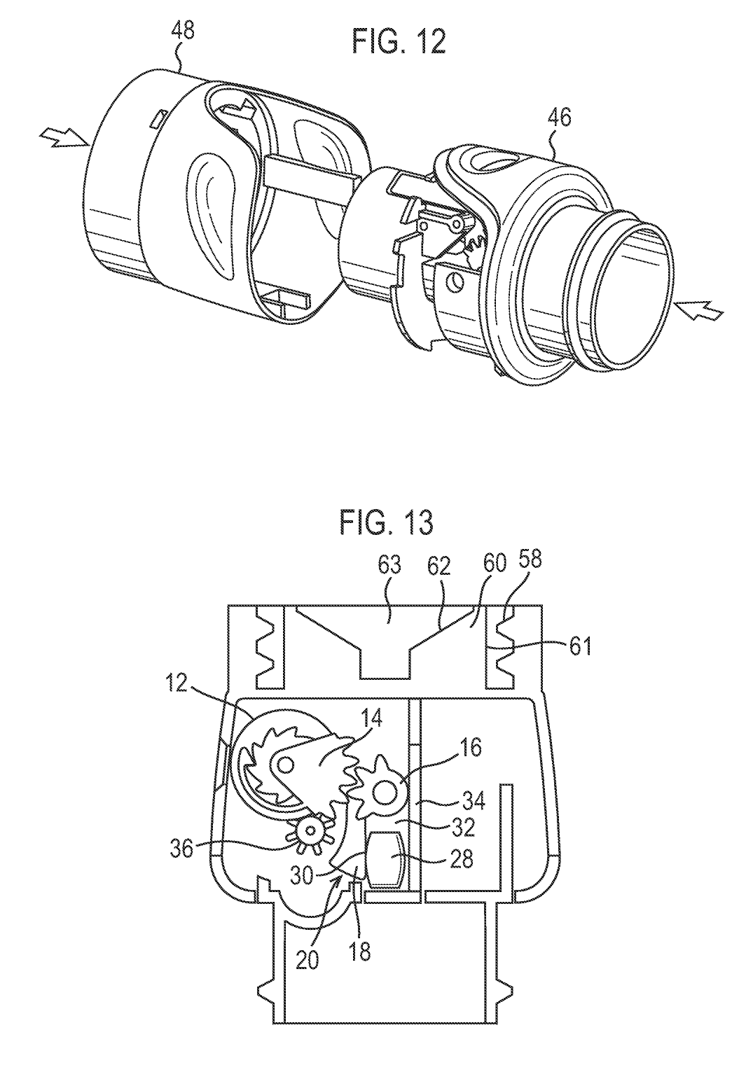

Once the working mechanism 21 has been reassembled, as shown in FIG. 10, the upper and lower casings 46, 48 can be snap fitted together around the working mechanism 21, as shown in FIG. 12. This completes the (re)assembly of the pill dispenser 24.

The operation of the pill detect feature of the mechanical actuation indicator counter 10 will now be described with reference to FIGS. 13, 14 and 15.

FIG. 13 schematically shows a tablet or pill 28 within the pill delivery or dispensement channel 32 of the pill dispenser 24, with the two chassis components 50, 52 in an at rest or default state. Being only a schematic drawing, only parts of the channel 32 are shown in these Figures.

The pill 28 has passed from the container 26, through the tapered slot 63 of the extension piece 60, guided by the tapered wall 62 thereof, into that channel 32, under gravity. This path has oriented the pill 28.

FIGS. 14 and 15 show a second embodiment. It is similar to the embodiment of FIG. 13 but it has additionally got a check pawl 57 for preventing the indicator wheels 12 from turning in the wrong direction. This feature is known in the art. The embodiment of FIG. 13, however, instead relies upon friction on the indicator wheels axle to prevent them from turning in the wrong direction.

In FIG. 14, the two chassis components 50, 52 have been axially displaced relative to each other from the ‘at rest’ position of FIG. 13 towards a pill delivery position. In this illustrated position, a moulded wall 34 of the first chassis component 50 has passed into the dispensement nozzle 54 to start to open a gap 59 between it and an inner or base wall of the nozzle. The pill or tablet 28 is therefore almost free to fall out of the channel 32 through the gap 59 for dispensement. Further (or complete) actuation of the pill dispenser by way of continued axial displacement of the two chassis components 50, 52, will make that gap 59 big enough for the tablet 28 to fall out of the channel 32, under gravity, through the gap 59. That would then be a dispensement.

In the position shown in FIG. 14, the pill 28 is still engaging the pill detect arm 18, but now at the endpoint of the arm 18, as indicated by arrow 35. As a result, the tablet 28 has held the pill detect arm 18 in a positive dispensement orientation during the actuation of pill dispenser. By holding the pill detection arm 18 in that orientation, the relative motion of the two chassis components 50, 52, which has caused a relative motion of the axes of both the drive gear 16 and the ratchet pawl 14, has allowed the engagement of teeth of the drive gear 16 with teeth of the ratchet pawl 14 to cause the ratchet pawl 14 to rotate about its axis. This motion, therefore, will have caused the counter 10 to count that actuation.

In comparison, FIG. 15 shows the result of an actuation when no pill is present in the channel 32 during the actuation of the pill dispenser 24. In this situation, the pill detect arm 18 has been free to rotate, as indicated by arrow 37, into a negative dispensement position 22. The rotation of the pill detector arm 18 has also caused a rotation of the drive gear 16 as the gear 16 moves relative to the axis of the ratchet pawl 14. That rotation allowed the drive gear to rotate around the ratchet pawl 14. Accordingly, the ratchet pawl 14 is not caused to rotate by that relative movement of the drive gear 16. The counter 10, therefore, will not have counted that actuation.

Upon releasing the two chassis components 50, 52 from the compressed (dispensement/actuation) state, the spring 27 will bias the chassis components 50, 52 apart again to their ‘at rest’ state, as shown in FIG. 13. During that resetting movement, if the actuation was a negative actuation, starting from the positions of FIG. 15, the drive gear 16 and the pill detect arm 18 will rotate back to their default positions, as shown in FIG. 13. That movement of the drive gear 16 will not cause any rotation of the ratchet pawl 14 since the drive gear 16 will again just rotate around the ratchet pawl 14. However, from the positive actuation position of FIG. 14, upon releasing the chassis components 50, 52, that return motion of the two chassis components 50, 52 back to their ‘at rest’ state will cause the ratchet pawl 14 to rotate back again to its start position of FIG. 13. That is by virtue of the engagement of the teeth 15 of the ratchet pawl 14 with the teeth of the drive gear 16. That rotation, however, will also not cause the indicator wheels 11 to rotate (i.e. back again to uncount the earlier count). That is because the ratchet arm 15 of the ratchet pawl 14 will instead ride up and over the saw-toothed surfaces 13 of the units wheel 12; the check pawl 57 ensures that this happens. The counter of the present invention, which in its preferred embodiment includes the above working mechanism 21, will not increment if there is no tablet in the dispensement channel during an actuation of the pill dispenser—a negative actuation. This therefore prevents miscounts. The counter will, however, count positive actuations.

The indicator wheels comprise a first wheel (the units wheel 12) and a second wheel (the tens wheel 19). The knock-gear 36 operates to transmit drive from the units wheel 12 to the tens wheel 19 at the end of each full rotation of the units wheel 12, as will be understood by the skilled person in the art.

A hundreds wheel might also be provided. A fourth wheel, if provided, would be a thousands wheel. For each such additional wheel a further knock-gear would be required for transmitting drive thereto from the adjacent (lower number denoting) wheel at the end of each full rotation thereof.

A further incremental wheel might be positioned in front of the units wheel, e.g. a “part day” or an “hours” wheel if the units wheel signifies the number of days. That additional wheel might then indicate time intervals or periods within each day. For example, the additional wheel might be a half day indicator wheel having AM and PM indicators repeating around the wheel (or equivalent indicators for a chosen local language). A knock gear could then be provided to knock on the units wheel every two knocks of the half day indicator wheel. This would be useful where a pill needs to be taken twice a day—a glance at the count would advise when the next pill should be taken—AM or PM, and the units wheel would also give the date on which the pill should be taken, e.g. 2^{nd} or 3^{rd}, etc. The counting mechanism, therefore acts as an aide memoire for the user.

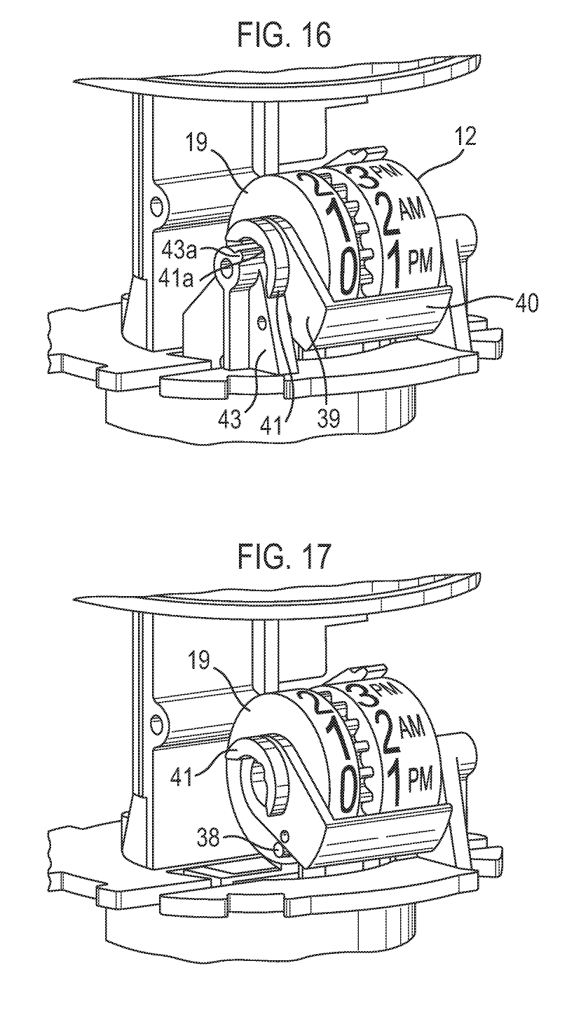

In the illustrated embodiment of FIGS. 16 to 23, however, the units indicator provides both a units count, by including units indicia, and medication interval indicia, e.g. alternating AM and PM indicia. The combined indicia therefore sequentially read: 1 PM, 2 AM, 3 PM . . . etc. Equivalent indicators for a chosen local language might instead be provided, however. These indicia are used where pills are to be taken twice a day.

With this preferred and advantageous arrangement, the counting mechanism counts the usage of the pills (or if counting down, counts the number of pills left in the container), as well as provides an aide memoire as to when the next pill should be taken.

For different dose intervals, different medication interval indicia would be provided, e.g. times or even a second set of numbers.

Still referring to FIGS. 16 to 23, the operation of a shutter mechanism for the counting mechanism 10 of that preferred embodiment will now be described.

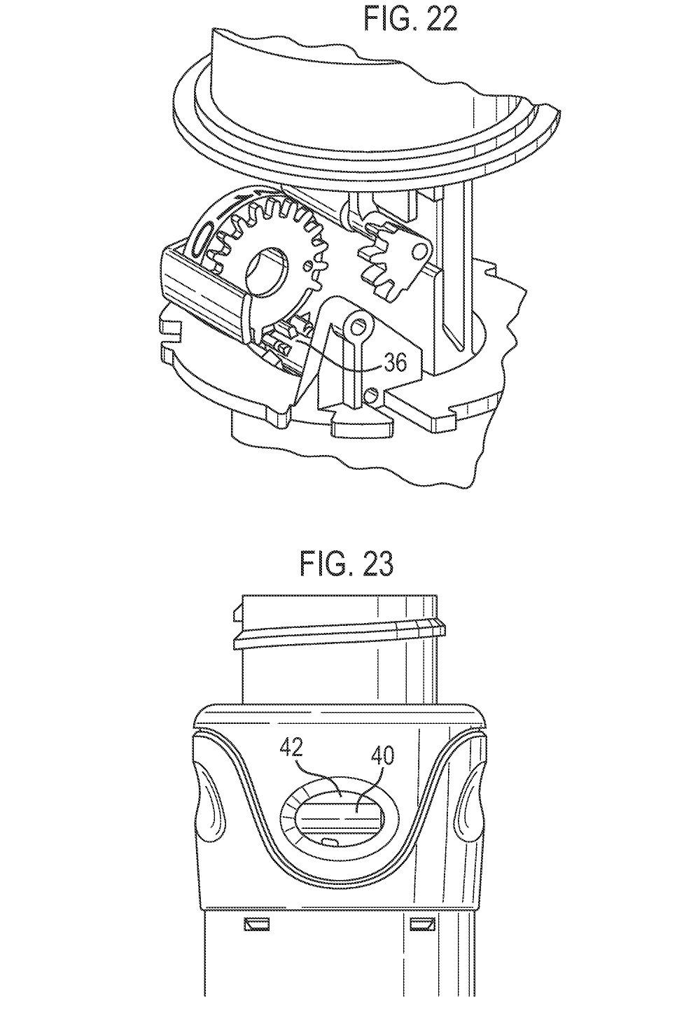

The counting mechanism has two “counting” wheels—the tens wheel 19 and the units wheel 12. These form a “barrel” counter. Further along the barrel counter from the tens wheel 19, away from the units wheel 12, a shutter device 39 is provided. The shutter device 39 comprises a hub and a shutter 40 that extends in a direction parallel to the axis of the indicator wheels 11, but spaced therefrom. The shutter 40 is long enough to extend over both of the indicator wheels, and wide enough to cover an indicia provided on a sector of the circumference of those wheels 11. The shutter 40, therefore, as shown in FIG. 23, when moved into registration with the window 42, will blank off the count.

The hub of the shutter device fits onto the same axle 29 as the wheels 11 and ratchet pawl 14.

Instead of another knock gear for driving the shutter's hub, a drive pin 38 extends sideways out from the tens wheel 19 for engaging the shutter device 39. This drive pin 38, as shown in FIG. 17, extends in a direction parallel to the axis of the indicator wheels 11, but is spaced from the axle 29.

As indicated in FIG. 17, the tens wheel 19 currently reads zero. The barrel counter is also counting down. A further rotation of the tens wheel 19, therefore, would cause the tens wheel 19 to be advanced beyond zero. That would provide a false reading (perhaps of 9 or 99). The shutter 40, therefore, is provided to prevent that false reading.

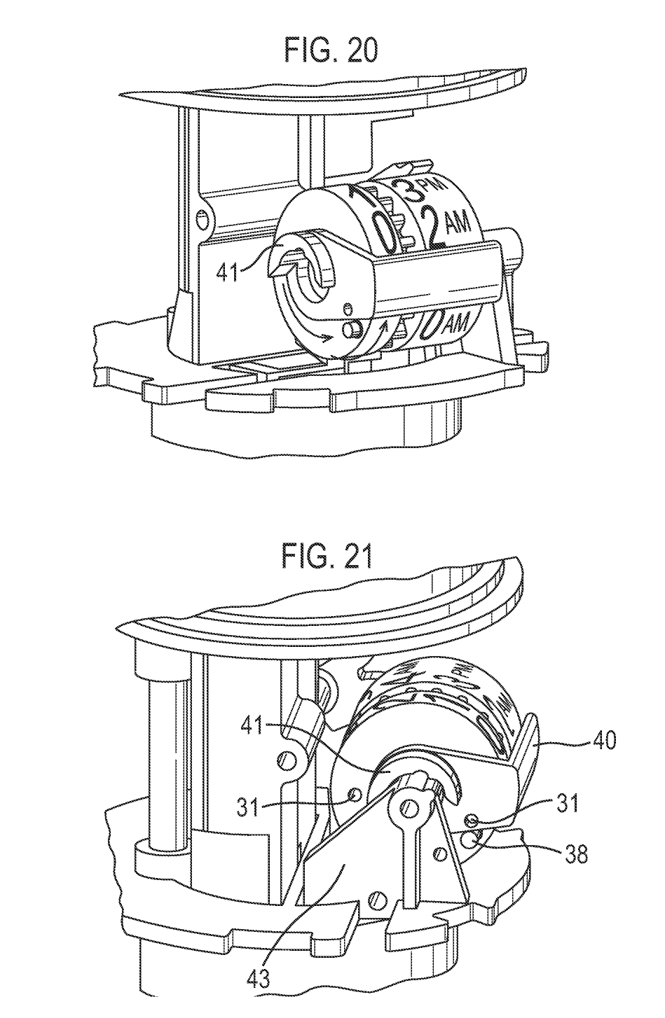

Because the drive pin 38 is in engagement with the shutter device 39, a further rotation of the tens wheel will cause the shutter device to rotate from its non-shuttering position shown in FIG. 16, at which the shutter device 39 is latched by co-operation of latching features 41a, 43a respectively provided on a rotation limiter 41 of the shutter device 39 and the axle support leg 43. That rotation will bring the shutter 40 into registration with the window 42, so as to blank off the count of the indicator wheels 11. FIG. 19 shows a count through the window 42. FIG. 20 is a cutaway view of the barrel counter and shutter 40 being brought up into a position to cover the window by the drive pin 38. FIG. 23 shows the shutter in that position, blanking off the window 42—the blanking position.

The rotation limiter 41 is an arcuate flange extending from the hub. The flange is in the form of an arc defining a partial circle that is coaxial with the hub and axle 29. When the shutter wheel 39 is not being engaged by the drive pin 38, a first end of the rotation limiter 41 rests against a front surface of its adjacent axle support leg 43. This keeps the shutter in a position one rotation away from its blanking position.

The rotation limiter 41 also serves to prevent the shutter 40 from being rotated beyond its blanking position. As shown in FIG. 21, the rotation limiter 41 at its second end can engage the other side of the axle support leg 43. Therefore, by making the arc the appropriate length, the shutter can only take up a short range of positions relative to the window 42. This will prevent the shutter 40 from rotating into undesired (or unrecoverable) positions by free rotation.

Once in its advanced, blanking position, the shutter 40 is securely held in that blanking position both by the drive pin 38 bearing against the shutter 40 and by the rotation limiter 41 bearing against the rear side of the axle support leg 43.

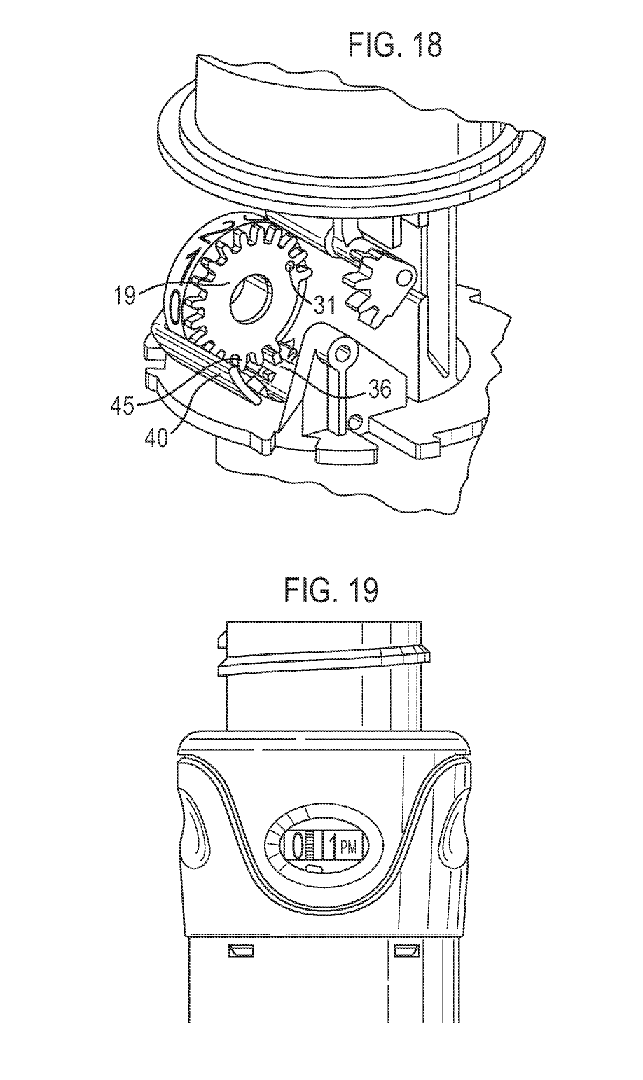

In addition to the rotation limiter 41, the gear form for the tens wheel 19 is also provided with a mechanism that prevents undesired further rotation after it has reached its end count (normally a zero count). As shown in FIG. 18, the gear form 45 of the tens wheel 19, which is usually engaged by the knock gear 36, extends only partially around the tens wheel. As a result, the knock gear 36 cannot further turn the tens wheel 19 once it reaches the missing gear form. Accordingly, once the shutter has been moved into its blanking position, the tens wheel 19 can no longer be rotated to further drive the shutter device.

It is preferred that the units wheel 12 will still be free to rotate as the ratchet pawl 14 advances it upon each positive actuation of the pill dispenser 24 even after the end count has been reached. This is because it is usual for more than the predetermined count of pills (the starting number for the counter) to be provided in the container 26. To cause a physical block of the units wheel 12 at that time might also cause a physical block for the actuation mechanism. That would then prevent dispensement of those remaining pills. In the disclosed embodiment, therefore, the units wheel 12 can still rotate despite neither the tens wheel 19 nor the shutter device 39 being further rotatable. The actuation mechanism can therefore still operate for dispensing those final pills, but the shutter 40 still shutters the window 42.

The present invention has been described above purely by way of example. It should be noted, however, that modifications in detail may be made within the scope of the invention as defined in the claims appended hereto.

What is claimed is:

1. A counter for a pill dispenser, the counter comprising:
two relatively moveable chassis components forming part of a pill dispensement mechanism;
a pill delivery or dispensement channel for a pill or tablet to pass through for dispensement; and
a counting mechanism, the counting mechanism comprising:
one or more actuation indicators;
a ratchet pawl for incrementally advancing a first of the one or more actuation indicators; and
a drive mechanism for activating the ratchet pawl;
the ratchet pawl being mounted to a first of the two chassis components and the drive mechanism being mounted to the second of the two chassis components such that, by moving the two chassis components relative to each other, the drive mechanism is moved relative to the ratchet pawl and the pill dispensement mechanism is actuated;
wherein:
the drive mechanism is connected to a pill detect feature that can move between a positive dispensement position and a negative dispensement position if the channel is clear, the negative dispensement position being such that at least a part of the pill detect feature is positioned within or blocking the pill delivery or dispensement channel, whereby the non-presence of a pill within the channel for dispensement, and therefore a failed dispensement, is confirmed, the movement from that positive dispensement position to the negative dispensement position preventing the drive mechanism from activating the ratchet pawl as the drive mechanism moves relative to the ratchet pawl.

2. The counter of claim 1, wherein the positive dispensement position of the pill detect feature is such that no part of the pill detect feature is positioned within the pill delivery or dispensement channel.

3. The counter of claim 1, wherein the pill detect feature forms part of a wall of the channel.

4. The counter of claim 1, wherein the drive mechanism and the pill detect feature are integrally formed as a single component of the counting mechanism.

5. The counter of claim 1, wherein the drive mechanism is a rotatable drive gear.

6. The counter of claim 1, wherein the pill detect feature is a pill detect arm that extends perpendicular to the axis of rotation of the drive gear.

7. The counter of claim 1, wherein the movement of the pill detect feature is a pivoting or rotational motion of it.

8. The counter of claim 1, wherein the or each actuation indicator is an indicator wheel.

9. The counter of claim 1, wherein the or each actuation indicator rotates about its central axis so as to alter its count.

10. The counter of claim 1, wherein the actuation indicator has a plurality of indicia thereon that will come into registration with a window of the dose counter, one indicia at a time, as the indicator advances or rotates, so as to display its count, through the window, by means of that registered indicia.

11. The counter of claim 1, wherein a shutter device is also provided for blanking off the indicia upon a final desired count being reached or exceeded.

12. The counter of claim 11, wherein the shutter device is a separate shutter wheel, and wherein the shutter wheel is actuated by a drive pin that extends from a side of an adjacent actuation indicator.

13. The counter of claim 1, wherein the pill detect feature comprises a pill engaging surface, that pill engaging surface defines at least a part of a first wall of the pill dispensement channel of the pill dispenser, and wherein a flange extends from a surface of the first of the two chassis components to define a wall of the pill dispensement channel that opposes the pill engaging surface.

14. The counter of claim 13, wherein third and fourth walls of the channel are provided by two further flat surfaces or flanges provided on or for the two chassis components.

15. The counter of claim 1, wherein the drive mechanism is a drive gear that is mounted for rotation about a fixed axis relative to the second chassis component, with the ratchet pawl and actuation indicators, in the form of rotatable actuation indicator wheels, being mounted for rotation about one or more fixed axes relative to the first chassis component.

16. The counter of claim 15, wherein the axis of the ratchet pawl is parallel to the axis of the drive gear, and remains so during the relative motion of the axes as the two chassis components move relative to each other during an actuation of the pill dispenser.

17. The counter of claim 1, wherein the axis of rotation of the ratchet pawl is coaxial with an axis of rotation of an or each actuation indicator.

18. The counter of claim 17, wherein the ratchet pawl and each rotatable actuation indicator are all fitted on a single axle for rotation thereabout.

19. The counter of claim 1, wherein two or more actuation indicators are provided, both in the form of rotatable actuation indicator wheels, the wheels being interlinked by one or more knock gears.

20. The counter of claim 19, wherein the rotatable actuation indicator wheels comprise a first wheel—the units wheel, and a second wheel—the tens wheel.

21. The counter of claim 20, wherein the units indicator provides both a count, by including units indicia, and medication interval indicia, wherein the medication interval indicia provide an aide memoire for a user as to either when the last actuation occurred or when to next actuate the pill dispensement mechanism for dispensing a pill therefrom.

22. The counter of claim 21, wherein the medication interval indicia comprise alternating AM and PM indicia.

23. A counter for a pill dispenser comprising actuation indicators for indicating a count of actuations of the pill dispenser by way of at least units indicia on a units indicator and tens indicia on a tens indicator, the counter having an arrangement for the actuation indicators in which the units indicator provides both a count, by way of its units indicia, and also medication interval indicia, wherein the medication interval indicia provide an aide memoire for a user as to either when the last actuation occurred or when to next actuate the dispenser for dispensing a pill therefrom.

24. The counter of claim 23, wherein the medication interval indicia comprise alternating AM and PM indicia.

25. The counter of claim 23, when also in accordance with claim 1.

26. A counter for a pill dispenser comprising actuation indicators for indicating a count of actuations of the pill dispenser by way of at least units indicia on a units indicator and tens indicia on a tens indicator, wherein a shutter device is also provided for blanking off the indicia upon a final desired count being reached or exceeded.

27. The counter of claim 26, wherein the shutter device is a separate shutter wheel, and wherein the shutter wheel is actuated by a drive pin that extends from a side of an adjacent actuation indicator.

28. The counter of claim 26, when also in accordance with claim 1.

29. A pill dispenser comprising a counter according to claim 1.

30. The pill dispenser of claim 29, attached to a container containing a plurality of pills or tablets.

31. The pill dispenser of claim 29, wherein a count from the counter is indicated by the indicia through a window in the outer casing of the pill dispenser.

32. The pill dispenser of claim 29, wherein an outer casing of the pill dispenser comprises an upper casing and a lower casing that are separable to allow servicing of the counting mechanism contained within the casing.

33. A method of counting positive actuations of a pill dispenser, a positive actuation comprising a pill dispensement from the pill dispenser upon an actuation of the pill dispenser, the method comprising:
providing a pill dispenser having a counter, the pill dispenser having a pill dispensement mechanism, an actuation of which requiring a motion of a first chassis component relative to a second chassis component in order for a pill dispensement to occur, by which motion a pill can move along a channel of the pill dispenser, wherein:
upon a positive dispensement, a tablet or pill passing along the channel will engage a pill engaging surface of a pill detect feature mounted within the pill dispenser as the pill or tablet passes out of or through the channel of the pill dispenser, that engagement maintaining the pill detect feature in a first position relative to a feature of the pill dispenser, that feature being either the channel or one of the two chassis components, whereby the counter will be advanced by that relative motion of the two chassis components so as to count the actuation, and wherein,
upon a negative actuation, a negative actuation comprising no pill dispensement from the pill dispenser upon an actuation of the pill dispenser since a pill for dispensement upon that actuation is not present in the channel, no pill will engage the pill engaging surface of the pill detect feature, thereby allowing the pill detect feature to move relative to that feature (either the channel or that one of the two chassis components) upon the actuation of the pill dispensement mechanism, which movement disables the counter or prevents the counter from counting that actuation.

34. The method of claim 33, wherein the movement of the pill detect feature involves a rotation of both the pill detect feature and a drive gear of the counter, the drive gear being connected to the pill detect feature.

35. The method of claim 33, wherein the motion of a first chassis component relative to a second chassis component causes a movement of a drive gear relative to a ratchet pawl of the counter.

36. The method of claim 35, wherein teeth of the drive gear engage teeth of the ratchet pawl.

37. The method of claim 35, wherein the relative movement of the chassis components cause a primary drive movement of the drive gear, that movement being relative to the axis of the ratchet pawl, and the movement of the pill detect feature upon a negative dispensement causes a secondary non-drive movement of the drive gear, that secondary movement preventing the drive gear from driving the ratchet pawl during the drive gears primary movement.

38. The method of claim 37, wherein the primary movement is a linear movement.

39. The method of claim 37, wherein the secondary movement is a rotational movement.

40. The method of claim 33, carried out using the counter of claim 1, wherein the counter and pill detect feature from claim 33 form the counter of claim 1.

41. The method of claim 33, carried out using the pill dispenser of claim 29, wherein the counter and pill detect feature from claim 33 form the counter for the pill dispenser of claim 29.

42. The method of claim 40, wherein the rotation of the pill detect feature during a negative dispensement causes the swinging of an arm of the pill detect feature through or into the pill dispensement channel, which swinging results in a rotation of the drive mechanism, which is in the form of a drive gear, about its axis as the drive gear moves relative to the axis of the ratchet pawl, whereby the drive gear rotates around the ratchet pawl so as not to rotate the ratchet pawl about the ratchet pawl's axis as a result of the motion of the drive gear relative to the axis of the ratchet pawl and wherein, during a positive dispensement, no such swinging of the arm occurs, whereby the drive gear does not rotate, so that the movement of the drive gear relative to the axis of the ratchet pawl causes rotation of the ratchet pawl.

43. A recorder for a pill dispenser to record dispensing of pills by the pill
dispenser on actuation thereof, the recorder having a mechanical recording mechanism which includes a driver for driving the recording mechanism in response to dispensing of a pill by the pill dispenser on actuation thereof, wherein the driver has a driving mode, in which it drives the recording mechanism, and a non-driving mode, in which it does not drive the recording mechanism, and wherein the driver is configured and arranged so as to adopt the non-driving mode when no pill is dispensed on actuation of the pill dispenser and to adopt the driving mode when such actuation results in dispensing of a pill.

44. The recorder of claim 43 in which the driver is configured and arranged to be placed in the driving mode by a pill being dispensed on actuation of the pill dispenser.

45. The recorder of claim 43, wherein the driver's driving and non-driving modes correspond to different positions of the driver in the recorder.

46. The recorder of claim 43, wherein the driver has a drive surface for engaging a driven surface of the recording mechanism to drive the recording mechanism and wherein the drive surface is only in driving engagement with the driven surface in the driving mode of the driver.

47. The recorder of claim 43, wherein the drive and driven surfaces are gear forms.

48. A pill dispenser incorporating a recorder according to claim 43.

49. The dispenser of claim 48, wherein the dispenser has a pill dispensing path which a pill traverses when dispensed on actuation of the dispenser, wherein the driver is configured and arranged to be maintained in its driving mode by a pill traversing the pill dispensing path on actuation of the dispenser (a “dispensing actuation event”) and to adopt the non-driving mode if no pill traverses the path on actuation of the dispenser (a “non-dispensing actuation event”).

50. The dispenser of claim 49, wherein the driver has a control surface configured and arranged for a pill to bear against during a dispensing actuation event to maintain the driver in the driving mode.

51. (canceled)

52. (canceled)

53. (canceled)

54. (canceled)

55. (canceled)
